(19) United States
(12) Patent Application Publication
(10) Pub. No.: US 2025/0237542 A1
(43) Pub. Date: Jul. 24, 2025

(54) DECOUPLING UNIT FOR A VIBRONIC SENSOR

(71) Applicant: Endress+Hauser SE+Co. KG, Maulburg (DE)

(72) Inventors: Benjamin Mack, Lörrach (DE); Jan Schleiferböck, Rümmingen (DE); Sergey Lopatin, Lörrach (DE); Peter Wimberger, Schopfheim (DE); Markus Franzke, Schwörstadt-Dossenbach (DE); Tobias Brengartner, Emmendingen (DE)

(21) Appl. No.: 18/698,995

(22) PCT Filed: Sep. 22, 2022
(86) PCT No.: PCT/EP2022/076344

§ 371 Date: Apr. 5, 2024

(30) Foreign Application Priority Data
Oct. 7, 2021 (DE) 10 2021 126 093.0

(51) Int. Cl. G01H 11/08; G01F 1/667; G01F 23/296

(52) U.S. Cl. CPC G01H 11/08; G01F 1/667; G01F 23/2968

(57) ABSTRACT

A decoupling unit for a device for determining and/or monitoring a process variable of a medium includes a sensor unit having a mechanically vibratable unit and a drive/receiving unit, which is configured to excite the vibratable unit to vibrate using an electrical excitation signal, to receive the vibrations of the vibratable unit, and to convert the vibrations into an electrical reception signal. The decoupling unit includes a tubular body, wherein a first end region is configured to connect to the sensor unit of the device and a second end region is configured to connect to a further component of the device, in particular an extension element, or a housing of an electronics system of the device, and wherein a wall thickness of the tubular body is variable along a longitudinal axis of the tubular body.

The invention relates to a decoupling unit for a device for determining and/or monitoring

at least one process variable of a medium, comprising a sensor unit having a mechanically vibratable unit and a drive/receiving unit, as well as a device having a decoupling unit according to the invention. The medium is located in a container, e.g., in a reservoir or in a pipe.

Vibronic sensors are often used in process and/or automation engineering. In the case of fill level measuring devices, they have at least one mechanically vibratable unit such as, for example, a vibrating fork, a single rod, or a diaphragm. In operation, this is excited to produce mechanical vibrations by means of a drive/receiving unit, often in the form of an electromechanical transducer unit, which in turn can be a piezoelectric drive or an electromagnetic drive, for example. A wide variety of corresponding field devices are produced by the applicant and are distributed under the name LIQUIPHANT or SOLIPHANT, for example. The underlying measurement principles are known in principle from numerous publications. The drive/receiving unit excites the mechanically vibratable unit to induce mechanical vibrations by means of an electrical excitation signal. Conversely, the drive/receiving unit can receive the mechanical vibrations of the mechanically vibratable unit and convert same into an electrical reception signal. The drive/receiving unit is accordingly either a separate drive unit and a separate receiving unit or a combination drive/receiving unit.

In many instances, the drive/receiving unit is thereby part of an electrical resonant feedback circuit by means of which the excitation of the mechanically vibratable unit to produce mechanical vibrations takes place. For example, the resonant circuit condition according to which the amplification factor is ≥1 and all phases occurring in the resonant circuit result in a multiple of 360° must be fulfilled for a resonant vibration. To excite and fulfill the resonant circuit condition, a defined phase shift must be ensured between the excitation signal and the reception signal. A predeterminable value for the phase shift, thus a setpoint for the phase shift between the excitation signal and the reception signal, is therefore often set. For this purpose, various solutions, both analog and digital methods, have become known from the prior art, as described, for example, in documents DE102006034105A1, DE102007013557A1, DE102005015547A1, DE102009026685A1, DE102009028022A1, DE102010030982A1, or DE00102010030982A1.

Both the excitation signal and the reception signal are characterized by their frequency ω, amplitude A, and/or phase Φ. Accordingly, changes in these variables are usually used to determine the respective process variable. The process variable can, for example, be a fill level, a specified fill level, or the density or the viscosity of the medium, and also the flow rate. Given a vibronic level switch for liquids, for example, a distinction is made between whether the vibratable unit is covered by the liquid or vibrates freely. These two conditions, the free condition and the covered condition, are differentiated, for example, on the basis of different resonant frequencies, on the basis of a frequency shift.

The density and/or viscosity can in turn only be determined with such a measuring device if the vibratable unit is completely covered by the medium. In connection with the determination of the density and/or viscosity, different possibilities have likewise become known from the prior art, such as those disclosed in documents DE10050299A1, DE102007043811A1, DE10057974A1, DE102006033819A1, DE102015102834A1, or DE102016112743A1.

Various vibronic sensors are known from the documents DE102012100728A1 or DE102017130527A1 in which the piezoelectric elements are arranged at least partially inside the vibratable unit. With such and similar arrangements, a plurality of process variables can advantageously be determined with a single sensor and used to characterize different processes, as known, for example, from the documents WO2020/094266A1, DE102019116150A1, DE102019116151A1, DE02019116152A1, DE102019110821A1, DE102020105214A1 or DE102020116278A1.

In vibronic sensors, in principle, the vibratable unit is excited to mechanical vibrations, which in turn are influenced by properties of various media. For high measurement accuracy, it is accordingly necessary to decouple the mechanical vibration system from external disturbances as much as possible. Conversely, forces which result from the vibration movement of the vibratable unit, in particular due to a lack of perfect symmetries, and which can, for example, act on the corresponding container or on a process connector arranged thereon, must be reduced or eliminated in order to prevent damage. Such an energy outflow from the vibration system also results in a change in vibration behavior.

The object on which the invention is based is thus to improve the measurement accuracy of vibronic sensors.

This object is achieved by the decoupling unit according to claim 1 and by the device according to claim 8.

With regard to the decoupling unit, the object on which the invention is based is achieved by a decoupling unit for a device for determining and/or monitoring at least one process variable of a medium, comprising a sensor unit having a mechanically vibratable unit and a driving/receiving unit which is configured to excite the mechanically vibratable unit to mechanically vibrate by means of an electrical excitation signal and to receive the mechanical vibrations of the mechanically vibratable unit and convert the mechanical vibrations into an electrical reception signal. According to the invention, the decoupling unit comprises a tubular body, wherein a first end region of the tubular body is configured for connection to the sensor unit of the device, and a second end region of the tubular body is configured for connection to a further component of the device, in particular an extension element, or a housing of an electronics system of the device, and wherein a wall thickness of the tubular body is variable along a longitudinal axis of the tubular body.

The decoupling unit is used for mechanical vibration decoupling of a vibronic sensor. By means of the decoupling unit, an outflow of energy to the process connector or the container from the vibration system of the vibronic sensor used in each case can be prevented. The energy flowing from the vibration system of the vibronic sensor is directly dissipated by the decoupling unit. The energy flowing from the vibration system results, for example, from small asymmetries in the region of the vibratable unit, in particular due to the manufacturing process. In the event that the vibratable unit is a vibrating fork with two vibrating rods, asymmetries of the two vibrating rods relative to one or relative to their arrangement relative to one another are particularly important in this context. If the outflowing energy is not dissipated by a decoupling unit according to the invention, a change in the resonance properties, in particular in the resonant frequency of the vibratable unit, may occur for example. However, a frequency-stable vibration behavior is of paramount importance to the measurement accuracy of vibronic sensors. Frequency stability is particularly relevant in the event that the density of the medium is to be determined by means of the vibronic sensor.

To achieve effective vibration decoupling, a wall thickness of the tubular body is variable along a longitudinal axis. In particular, at least one abrupt, step-like or discontinuous change in the wall thickness takes place along a longitudinal axis of the tubular body. This leads to, in particular abrupt, changes in the rigidity of the tubular body along the longitudinal axis, which in turn contributes decisively to the vibration decoupling and frequency stability of the vibronic sensor.

It should be noted that various embodiments of the wall of the tubular body are conceivable within the scope of the present invention. For example, the outer or the inner wall can be straight, while the respective other wall has a nonlinear profile, at least in portions, in order to achieve a variation in the wall thickness. However, it is also conceivable that not only the inner wall but also the outer wall have a nonlinear profile at least in portions. A nonlinear profile means in particular the presence of at least one step, edge, or rounding.

In one embodiment, the tubular body in at least one subregion along the longitudinal axis has a wall thickness which is greater or smaller than a wall thickness of the wall of the tubular body outside the subregion. In the subregion, the wall is accordingly thicker or thinner than outside the subregion. The decoupling unit accordingly has a changed rigidity in the subregion, which in turn contributes to the vibration decoupling.

In this context, it is advantageous if the wall thickness in the subregion is greater or smaller, at least by a factor of two, preferably at least by a factor of 5, than the wall thickness outside the subregion.

In a further embodiment, the tubular body in the at least one subregion has a recess, in particular a notch or groove, which can be arranged in the region of an inner or outer wall of the tubular body. 13

In a further embodiment of the decoupling unit, the tubular body in the at least one subregion has an inner or outer diameter perpendicular to the longitudinal axis of the tubular body which is greater than an inner or outer diameter of the tubular body outside the subregion.

In a further embodiment of the decoupling unit, a distance of the at least one subregion from the first end region parallel to the longitudinal axis of the tubular body is at least half a diameter, in particular the outer diameter, of the tubular body.

Finally, an embodiment of the decoupling unit also includes a distance of the at least one subregion from the first end region parallel to the longitudinal axis of the tubular body being no more than four times a diameter, in particular the outer diameter, of the tubular body.

The object on which the invention is based is also achieved by a device for determining and/or monitoring at least one process variable of a medium, comprising a sensor unit having a mechanically vibratable unit and a drive/receiving unit which is configured to excite the mechanically vibratable unit to mechanically vibrate by means of an electrical excitation signal and to receive the mechanical vibrations of the mechanically vibratable unit and convert the mechanical vibrations into a first electrical reception signal, an electronics system which is configured to determine the at least one process variable based on the reception signal, and a decoupling unit according to the invention according to at least one of the above-described embodiments.

The mechanically vibratable unit is, for example, a diaphragm, a single rod, an arrangement of at least two vibrating elements, or a vibrating fork.

The excitation signal generates mechanical vibrations of the vibratable unit, which, when the vibratable unit is covered by medium, are influenced by the properties of the medium. Accordingly, a statement about the at least one process variable can be made on the basis of the reception signal representing the vibrations of the vibratable unit.

The excitation signal is, for example, an electrical signal having at least one specifiable frequency, especially a sinusoidal or a rectangular-wave signal. The mechanically vibratable unit is preferably excited at least temporarily to produce resonance vibrations. The device can furthermore comprise an electronics system, for example for signal acquisition and/or signal feeding.

In one embodiment of the device, the drive/receiving unit comprises at least one piezoelectric element. However, a plurality of piezoelectric elements, which may be arranged at different positions relative to the vibratable unit, may also be present. Alternatively, however, electromagnetic drive/receiving units are also conceivable.

It is advantageous if the piezoelectric element is arranged at least partially in an inner volume of the vibratable unit. For example, the vibratable unit can comprise at least one cavity into which the piezoelectric element is introduced. The cavity is then preferably filled with a filling, in particular with a potting material, for example an adhesive, or the piezoelectric element is cast in the cavity.

It is also advantageous if the device is designed to emit a transmission signal and to receive a second reception signal, and to determine and/or monitor the at least one process variable using the first and/or second reception signal. In this case, it is a vibronic multisensor.

In this case, the piezoelectric element is used, on the one hand, as a drive/receiving unit to generate the mechanical vibrations of the mechanically vibratable unit and to transmit the transmission signal, which is received in the form of the second reception signal. The transmission signal is preferably an ultrasound signal, especially a pulsed ultrasound signal, especially at least one ultrasound pulse. An ultrasound-based measurement is accordingly carried out within the scope of the present invention as the second measurement method that is used.

If, on its way, the transmission signal passes through the medium at least temporarily and in segments, it is likewise influenced by the physical and/or chemical properties of the medium and can be used accordingly for determining a process variable of the medium. In the event that an excitation signal and a transmission signal are generated, at least two measurement principles can thus be realized in a single device and at least two different process variables can be evaluated. The two reception signals can, advantageously, be evaluated independently of one another. In this way, according to the invention, the number of determinable process variables can be significantly increased, which results in a higher functionality of the respective sensor or in an extended field of application. In connection with the additional generation of a transmission signal, reference is also made to WO2020/094266A1, to which reference is made in full within the scope of the present invention.

Finally, in relation to the device, it is also advantageous if the mechanically vibratable unit is a vibrating fork having a first and a second vibrating element, and wherein the at least one piezoelectric element is arranged at least partially in one of the two vibrating elements, or wherein a piezoelectric element is arranged in each vibrating element. Corresponding embodiments of such a sensor unit have been described, for example, in the documents DE102012100728A1 and DE102017130527A1. Both applications are likewise referred to in their entirety within the scope of the present invention. However, the possible embodiments of the sensor unit described in the two documents are exemplary, possible structural embodiments of the sensor unit. It is also not absolutely necessary to arrange the piezoelectric elements exclusively in the region of the vibrating elements. Rather, individual piezoelectric elements of those used may also be arranged in the region of the diaphragm, or in further vibrating elements which are not used for the vibronic excitation and which are likewise applied to the diaphragm.

The invention is explained in greater detail with reference to the following figures. In the figures:

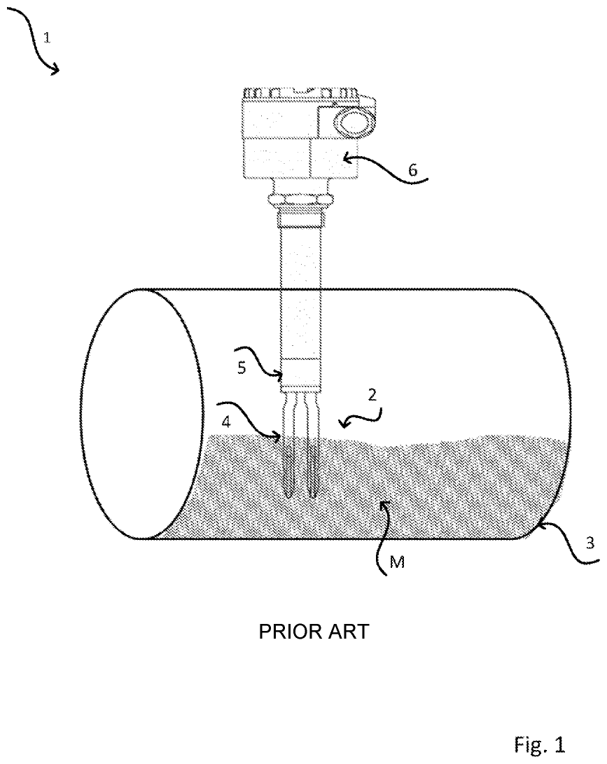

FIG. 1: is a schematic drawing of a vibronic sensor according to the prior art;

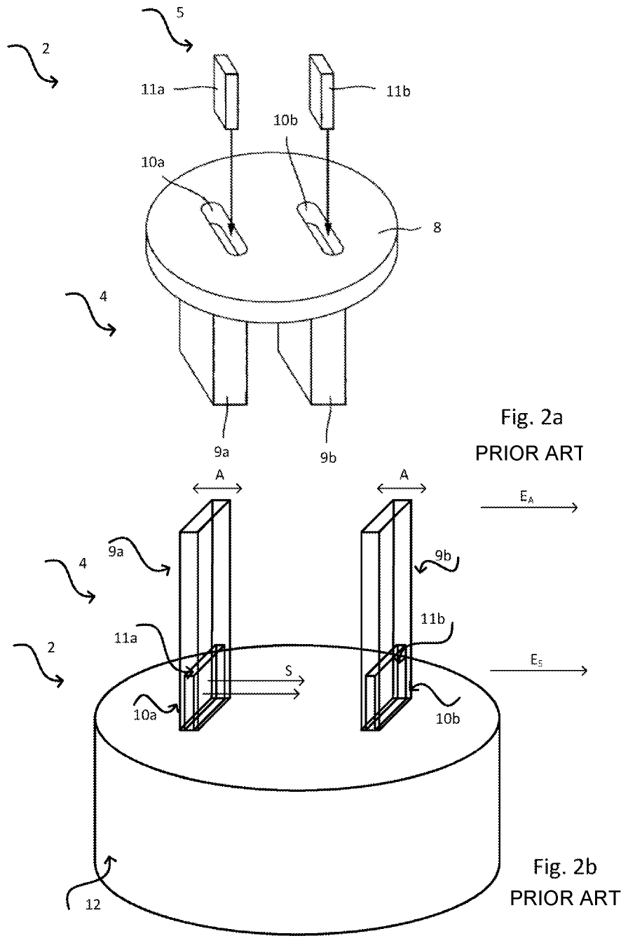

FIG. 2: shows various possible embodiments for vibronic sensors according to the prior art in which piezoelectric elements are arranged within the vibrating elements;

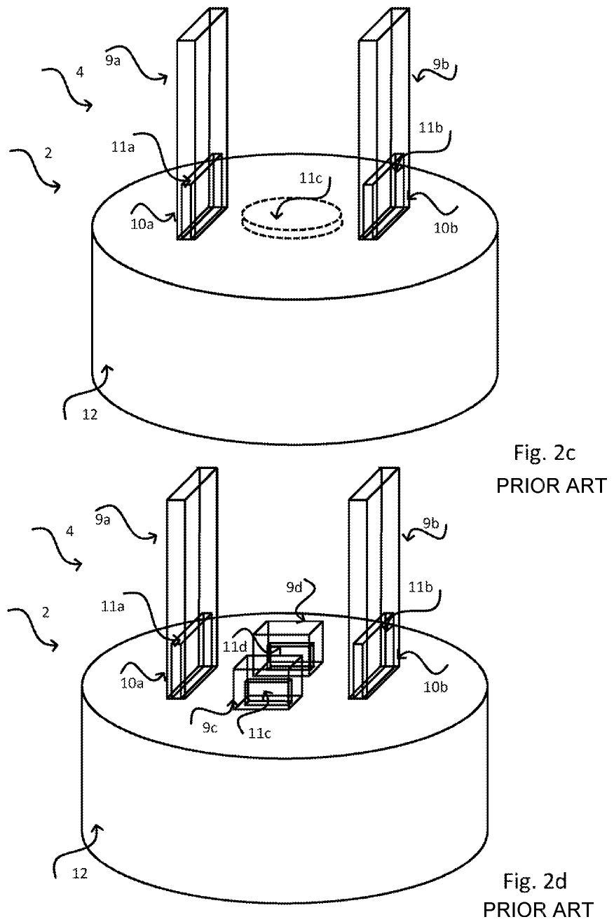

FIG. 3: shows preferred embodiments for a vibronic sensor having a coupling unit according to the invention; and

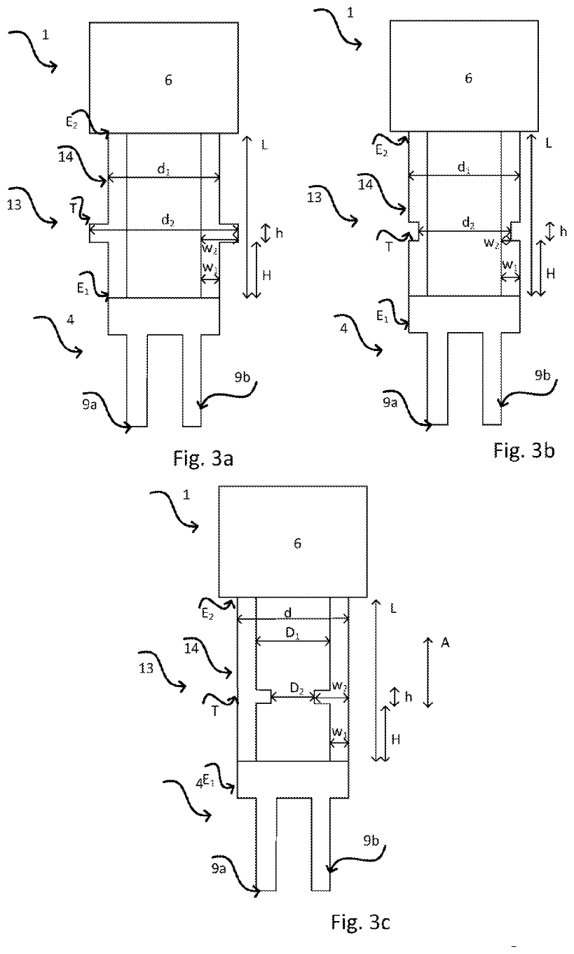

FIG. 4: shows the frequency change of a vibronic sensor as a function of different wall thicknesses in a decoupling unit according to FIG. 3a.

In the figures, identical elements are respectively provided with the same reference signs.

FIG. 1 shows a vibronic sensor 1 having a sensor unit 2. The sensor has a mechanically vibratable unit 4, in the form of a vibrating fork, which is partially dipped into a medium M which is located in a reservoir 3. The vibratable unit 4 is excited by the excitation/receiving unit 5 to mechanical vibrations and can, for example, be excited by means of a piezoelectric stack drive or bimorphic drive. Other vibronic sensors have electromagnetic drive/receiving units 5, for example. It is possible to use a single drive/receiving unit 5 which serves both to excite the mechanical vibrations and to detect them. However, it is likewise conceivable to realize one each, a drive unit and a receiving unit. Furthermore depicted in FIG. 1 is an electronics unit 6 by means of which the signal acquisition, evaluation, and/or feed takes place.

FIG. 2 shows, by way of example, different sensor units 2 of vibronic sensors 1 in which the piezoelectric elements 5 are arranged in an inner volume of the vibratable unit. The 8 mechanically vibratable unit 4 shown in FIG. 2a comprises two vibrating elements 9a, 9b, which are mounted on a base 8 and which are therefore also referred to as fork teeth. Optionally, a paddle may respectively also be formed on the end sides of the two vibrating elements 9a, 9b (not shown here). In each of the two vibrating elements 9a, 9b, a cavity 10a, 10b, especially, a pocket-like cavity, is respectively introduced, in which at least one piezoelectric element 11a, 11b of the drive/receiving unit 5 is respectively arranged. Preferably, the piezoelectric elements 11a and 11b are embedded in the cavities 10a and 10b. The cavities 10a, 10b can be such that the two piezoelectric elements 11a, 11b are located completely or partly in the region of the two vibrating elements 9a, 9b. Such an arrangement along with similar arrangements are extensively described in DE102012100728A1.

Another possible exemplary embodiment of a sensor unit 2 is depicted in FIG. 2b. The mechanically vibratable unit 4 has two vibrating elements 9a, 9b, which are aligned in parallel to one another and are configured here in a rod-shaped manner. They are mounted on a disk-shaped element 12 and can be excited separately from one another to vibrate mechanically. Their vibrations can likewise be received and evaluated separately from one another. The two vibrating elements 9a and 9b respectively have a cavity 10a and 10b, in which at least one piezoelectric element 11a and 11b is respectively arranged in the region facing the disk-shaped element 12. With respect to the embodiment according to FIG. 2b, reference is again made to the as yet unpublished German patent application with reference number DE102017130527A1.

As shown schematically in FIG. 2b, the sensor unit 2 is supplied on the one hand with an excitation signal A such that mechanical vibrations are excited in the vibratable unit 4. The vibrations are generated by means of the two piezoelectric elements 11a and 11b. It is conceivable both for both piezoelectric elements to be supplied with the same excitation signal A and for the first vibrating element 11a to be supplied with a first excitation signal A₁ and the second vibrating element 11b to be supplied with a second excitation signal A₂. It is also conceivable for a first reception signal E_{A} to be received on the basis of the mechanical vibrations, or for each vibrating element 9a, 9b to receive a separate reception signal E_{A1} or E_{A2}.

In addition, for example, a transmission signal S can also be emitted from the first piezoelectric element 11a, which is received in the form of a second reception signal E_{S} by the second piezoelectric element 11b. Since the two piezoelectric elements 11a and 11b are arranged at least in the region of the vibrating elements 9a and 9b, the transmission signal S passes through the medium M, provided that the sensor unit 2 is in contact with the medium M and is influenced accordingly by the properties of the medium M. The transmission signal S is preferably an ultrasound signal, especially a pulsed ultrasound signal, especially at least one ultrasound pulse. However, it is also conceivable for the transmission signal S to be emitted by the first piezoelectric element 11a in the region of the first vibrating element 9a and to be reflected at the second vibrating element 9b. In this case, the second reception signal E_{S} is received by the first piezoelectric element 11a. In this case, the transmission signal S passes through the medium M twice, which leads to a doubling of a transit time T of the transmission signal S.

In addition to these two embodiments shown of a device 1 according to the invention, numerous other variants are also conceivable, which likewise fall within the present invention. For example, for the embodiments according to figures FIG. 2a and FIG. 2b, it is possible to use only one piezoelectric element 11a, 11b and to arrange it at least in one of the two vibrating elements 9a, 9b. In this case, the piezoelectric element 9a serves to generate the excitation signal and the transmission signal S, and to receive the first E₁ and the second reception signal E₂. The transmission signal S is then emitted from the first piezoelectric element 11a in the region of the first vibrating element 9a and reflected at the second vibrating element 9b so that the second reception signal E_{S} is also received by the first piezoelectric element 11a. In this case, the transmission signal S passes through the medium M twice, which leads to a doubling of a transit time T of the transmission signal S.

Another exemplary possibility is depicted in FIG. 2c. Here, a third piezoelectric element 11c is provided in the region of the diaphragm 12. The third piezoelectric element 11c serves to generate the excitation signal A and to receive the first reception signal E₁; the first 11a and the second piezoelectric element 11b serve to generate the transmission signal S or to receive the second reception signal E₂. Alternatively, it is possible, for example, to generate the excitation signal A and the transmission signal S and receive the second reception signal E₂ with the first 11a and/or the second piezoelectric element 11b, wherein the third piezoelectric element 11c serves to receive the first reception signal E₁. It is also possible to generate the transmission signal S with the first 11a and/or the second piezoelectric element 11b and the excitation signal A with the third piezoelectric element 11c and to receive the first E₁ and/or the second reception signal E₂ with the first 11a and/or the second piezoelectric element 11b. In the case of FIG. 2c, it is also possible for other embodiments to dispense with the first 11a or the second piezoelectric element 11b.

Yet another possible embodiment of the device 1 is the subject matter of FIG. 2d. Starting from the embodiment of FIG. 2b, the device comprises a third 9c and a fourth vibrating element 9d. However, the latter do not serve to generate vibrations. Rather, a third 11c and a fourth piezoelectric element 11d are respectively arranged in the additional elements 9c, 9d. In this case, the vibronic measurement is performed by means of the first two piezoelectric elements 11a, 11b and the ultrasonic measurement by means of the other two piezoelectric elements 11c, 11d. Here as well, a piezoelectric element, e.g., 11b and 11d, can be dispensed with depending on the measurement principle. For reasons of symmetry, however, it is advantageous to always use two additional vibrating elements 9c, 0d.

Some particularly preferred embodiments for decoupling units 13 according to the invention are shown in FIG. 3. The decoupling unit 13 comprises a tubular body 14 for which a wall thickness w along its longitudinal axis a is variable according to the invention. FIG. 3a shows a first embodiment for a vibronic sensor 1 having a vibratable unit 4 in the form of a vibrating fork and having an electronics system 6, wherein a decoupling unit 13 is arranged between the electronics system 6 and the vibratable unit 4. The decoupling unit 13 comprises a tubular body 14. A first end region E₁ of the body 14 is configured for connection to the sensor unit 2 and a second end region E₂ of the tubular body 14 is configured for connection to a housing of the electronics system 6. The wall thickness w of the body 14 is variable. In this case, the tubular body 14 has a wall thickness w₂ in the subregion T which is greater than a wall thickness w₁ outside the subregion T. Accordingly, a diameter d₂ of the body 14 in the subregion T is greater than a diameter d₁ outside the subregion T. For the variant shown in FIG. 3b, a wall thickness w₂ of the tubular body 14 in the subregion T is smaller than a wall thickness w₁ outside the subregion T. Accordingly, a diameter d₂ of the body 14 in the subregion T is smaller than a diameter d₁ outside the subregion T. In this case, the tubular body has, for example, a groove or a notch in the subregion T.

While the decoupling units 13 from FIGS. 3a and 3b are configured such that an outer diameter d₁, d₂ of the tubular body 14 varies, the outer diameter d is constant in the case of the embodiment of the decoupling unit 13 according to FIG. 3c. In this case, in contrast, an inner diameter D varies in such a way that an inner diameter D₁ in the subregion T is smaller than an inner diameter D₂ outside the subregion T. Again, this results in a wall thickness w₂ of the tubular body 14 in the subregion T which is greater than a wall thickness w₁ outside the subregion T. In addition to the embodiments shown here for the decoupling unit 13, numerous other embodiments are conceivable, which also fall within the scope of present invention. For example, there can be a plurality of subregions T with changed diameters d or D or changed wall thicknesses w. Distances H of the subregion T from the first E₁ or second E₂ end region or a height h of the subregion T can be selected differently.

Due to the special configuration of the decoupling unit 13, a change in the resonant frequency f of the vibronic sensor 1 due to energy flowing from the vibration system to a process connector in the container 3 in which the sensor 1 is used can be dissipated. The outflow of vibration energy results, for example, from production-related asymmetries in the region of the vibratable unit 4. Changes in the resonance characteristics of the vibratable unit 4 due to the energy otherwise flowing to the process connector can be effectively prevented in this way. This considerably increases the measurement accuracy of the corresponding sensor 1.

FIG. 4 shows the ratio of the resonant frequencies Δf₁/Δf₂ of a vibronic sensor 1 having a decoupling unit 13 with (Δf₁) and without (Δf₂) clamping, i.e., fastening the sensor 1 to a container 3 as a function of the length L of the tubular body 13 for different differences of the two wall thicknesses

Δw=w₁-w₂

and for different heights h of the subregion T for a decoupling unit 13 according to FIG. 3a. The exact geometry of the decoupling unit 13 and the exact ratios of the individual geometric parameters w, d, h, H relative to one another depend on the particular installation situation and the properties of the corresponding sensor 1. The decoupling unit 13 provides good mechanical vibration decoupling of the corresponding sensor 1.

### LIST OF REFERENCE SIGNS

1 Vibronic sensor
2 Sensor unit
3 Container
4 Vibratable unit
5 Drive/receiving unit
6 Electronics
8 Base
9a, 9b Vibrating elements
10a, 10b 11 Cavities
11a 11b 12 Piezoelectric elements
12 Disk-shaped element
13 Decoupling unit
14 Tubular body
M Medium
P Process variable
A Excitation signal
S Transmission signal
E_{A} First reception signal
E_{S} Second reception signal
E_{T} Third reception signal
ΔΦ Specifiable phase shift
E₁, E₂ End regions of the tubular body
d Outer diameter of the tubular body
D Inner diameter of the tubular body
W Wall thicknesses of the tubular body
L Length of the tubular body
T Subregion
H Distance from subregion to the first end region
h Height of the subregion

1-12. (canceled)

13. A decoupling unit for a device for determining and/or monitoring at least one process variable of a medium, the device comprising a sensor unit including a mechanically vibratable unit and a drive/receiving unit, which is configured to excite the vibratable unit to mechanically vibrate according to an electrical excitation signal, to receive the resulting mechanical vibrations of the vibratable unit, and to convert the mechanical vibrations into an electrical reception signal,
the decoupling unit comprising:
a tubular body including a wall having a wall thickness, wherein a first end region of the tubular body is configured to connect to the sensor unit, and a second end region of the tubular body is configured to connect to an extension element or a housing of an electronics system of the device, and
wherein the wall thickness of the tubular body is variable along a longitudinal axis of the tubular body.

14. The decoupling unit according to claim 13, wherein the tubular body, in at least one subregion along the longitudinal axis, has a subregion wall thickness, which is greater or smaller than the wall thickness of the wall of the tubular body outside the subregion.

15. The decoupling unit according to claim 14, wherein the subregion wall thickness is greater or smaller, at least by a factor of two, preferably at least by a factor of 5, than the wall thickness outside the subregion.

16. The decoupling unit according to claim 14, wherein the subregion wall thickness is greater or smaller, at least by a factor of 5, than the wall thickness outside the subregion.

17. The decoupling unit according to claim 13, wherein the tubular body in the at least one subregion includes a recess, notch or groove, disposed in a region of an inner wall or outer wall of the tubular body, wherein the wall of the tubular body includes the inner and outer wall.

18. The decoupling unit according to claim 14, wherein the tubular body, in the at least one subregion, includes an inner or outer diameter perpendicular to the longitudinal axis of the tubular body, which inner or outer diameter is greater than an inner or outer diameter of the tubular body outside the subregion.

19. The decoupling unit according to claim 14, wherein a distance of the at least one subregion from the first end region parallel to the longitudinal axis of the tubular body is at least half a diameter of the tubular body.

20. The decoupling unit according to claim 14, wherein a distance of the at least one subregion from the first end region parallel to the longitudinal axis of the tubular body is not more than four times a diameter of the tubular body.

21. A device for determining and/or monitoring at least one process variable of a medium, the device comprising:
a sensor unit comprising:
a mechanically vibratable unit; and
a drive/receiving unit configured to excite the vibratable unit to mechanically vibrate according to an electrical excitation signal, to receive the mechanical vibrations of the vibratable unit, and to convert the mechanical vibrations into an electrical first reception signal;
an electronics system configured to determine the at least one process variable based on the first reception signal; and
the decoupling unit according to claim 13.

22. The device according to claim 21, wherein the decoupling unit is connected to the sensor unit at one end and to the electronics system at an opposing end.

23. The device according to claim 21, wherein the drive/receiving unit comprises at least one piezoelectric element.

24. The device according to claim 23, wherein the piezoelectric element is disposed at least partially in an inner volume of the vibratable unit.

25. The device according to claim 23, wherein the vibratable unit is a vibrating fork including a first and a second vibrating element, and
wherein the at least one piezoelectric element is at least partially disposed in one of two vibrating elements of the vibrating fork, or
wherein in each case one piezoelectric element of the at least one piezoelectric element is disposed in each vibrating element of the vibrating fork.

26. The device according to claim 21, wherein the device is configured to:
emit a transmission signal and receive a second reception signal; and
determine the at least one process variable using the first and/or second reception signal.
